(19) United States
(12) Patent Application Publication
(10) Pub. No.: US 2025/0306539 A1
(43) Pub. Date: Oct. 2, 2025

(54) METHOD FOR VALIDATING A DETECTION OF CROSSING OF THE KARMAN LINE BY AN OBJECT PORTABLE BY A USER, IN PARTICULAR A WATCH

(71) Applicant: ETA SA Manufacture Horlogere Suisse, Grenchen (CH)

(72) Inventors: Andréa DARDANELLI, Neuchatel (CH); Laurent CHRISTE, Bienne (CH); Fabian DUBOIS, Le Locle (CH); Jean-Luc BOVERT, Solothurn (CH)

(73) Assignee: ETA SA Manufacture Horlogere Suisse, Grenchen (CH)

(21) Appl. No.: 18/616,559

(22) Filed: Mar. 26, 2024

(51) Int. Cl. G04G 21/02; G01C 21/16; G01D 1/04; G01P 15/00; G01P 15/08; G01P 15/18; G04B 47/06; G04G 9/00

(52) U.S. Cl. CPC G04G 21/02; G01C 21/16; G01D 1/04; G01P 15/003; G01P 15/0891; G01P 15/18; G04B 47/06; G04G 9/007; G01P 2015/0862

(57) ABSTRACT

A validation method relating to the detection of a crossing of the Kármán line by a portable object (2) carried on board a rocket and incorporating a detection device including an acceleration sensor (8) capable of measuring accelerations of the portable object and an electronic unit for processing the acceleration measurements made so as to detect a crossing of the Kármán line by the portable object. The method calculates a confidence index, relating to measurements made by the portable object for a variable which is a function of forces exerted on this portable object, and checks whether a condition given for the confidence index is met. Also, a portable object, in particular a watch, designed to be able to implement a method for detecting a crossing of the Kármán line and the validation method of the invention.

### CROSS-REFERENCE TO RELATED APPLICATIONS

This application claims priority based on European Patent Application No. 23176349.1 filed May 31, 2023, the entire disclosures of which are incorporated by reference herein.

### TECHNICAL FIELD OF THE INVENTION

The invention relates to an object portable by a user, in particular a watch, with a space application, the user being an astronaut or another individual travelling in space by means of a rocket or a space shuttle (hereinafter both referred to as a ‘rocket’). More specifically, the invention relates to a method for validating a detection of crossing of the Kármán line by such a portable object provided to this end with an autonomous detection device, the validation method being implemented by the portable object.

The Kármán line defines the conventional boundary between the Earth's atmosphere and space. It is typically agreed that it corresponds to an altitude of 100 km; however, this altitude varies according to various organisations, in particular between 85 km and 110 km. The Kármán line is also the boundary where, in order to maintain flight, a spacecraft must fly at substantially an orbital velocity that allows it to maintain its orbit around the Earth.

### TECHNOLOGICAL BACKGROUND

Various watches have been worn by astronauts on space missions. Some watches worn by astronauts have been selected for their robustness and precision, without having any functions specific to a flight or mission in space. Other watches, particularly of the electronic type, offer specific functions useful for missions in space. These specific functions typically relate to the measurement of time, for example for a countdown and/or alarms.

### SUMMARY OF THE INVENTION

The purpose of the present invention is to provide a method for validating a detection of a crossing of the Kármán line by an object portable by a user, in particular a watch, the detection and the validation being both performed by the portable object based on measurements made by this portable object during a detection phase of a detection method implemented by the portable object. Thus, such detection is intended to be carried out autonomously by the portable object during the detection phase of the detection method implemented by this portable object, and thus not by means of any real-time communication between the portable object and the rocket or with an external system, in particular one or more satellites supplying position information in space. The invention also relates to such an object portable by a user.

In particular, the portable object is intended to comprise a detection device formed by an acceleration sensor, a time base and an electronic unit, this detection device being arranged so as to be able, during a detection phase of a detection process/method implemented by the portable object, to measure accelerations experienced by the portable object and to process, in the electronic unit, the acceleration measurements made, so as to enable a detection of a crossing of the Kármán line by the portable object on the basis of these acceleration measurements and, in an advantageous alternative embodiment, on the basis of at least one predetermined reference value or a reference value calculated as a function of a predetermined correction coefficient and on the basis of an altitude selected by the user for the Kármán line within a given range of values, in particular between 85 and 110 km. By “predetermined”, it should be understood that the considered data are recorded in the portable object prior to the detection phase of the detection process/method.

It is not possible for a portable object such as a watch to incorporate a high-performance inertial navigation system, having an acceleration sensor designed to accurately measure acceleration along three axes of a coordinate frame of this portable object and an angular velocity sensor (gyrometer) designed to accurately measure angular velocity along these three axes, which allows the position of the portable object to be accurately determined in a fixed terrestrial coordinate frame. Furthermore, the cost of a precise inertial navigation system is very high. Thus, in a preferred embodiment, the portable object according to the invention is noteworthy in that it is designed to be able to autonomously detect the crossing of the Kármán line by this portable object on board a rocket of a given type, with, as the only technical means required, an acceleration sensor capable of measuring the components of an acceleration vector relative to the portable object in a coordinate frame linked to this portable object, a memory containing said predetermined reference value or said calculated reference value, and an electronic unit which is arranged to process the measurements supplied by the acceleration sensor. In order to detect whether the portable object has crossed the Kármán line, this portable object thus does not require a gyrometer, which can certainly be miniature, formed by a microelectromechanical system (also known by the acronym ‘MEMS’), but which is typically relatively inaccurate, and in any case not sufficiently accurate to allow for precise detection of changes in the orientation of a coordinate frame specific to said acceleration sensor during space flight, so as to be able to determine the vertical component of the acceleration of the rocket's motion at any time between take-off and the crossing of the Kármán line, and thus allow its altitude to be determined over time. For the measurements required to detect a crossing of the Kármán line, this preferred embodiment thus avoids the problem associated with small gyrometers, which are relatively inaccurate and thus unable to provide sufficiently accurate measurements of the angular velocity of the portable object to correctly determine its instantaneous orientation and then changes in its position in space, in particular its altitude, whereas a relatively inexpensive 3D acceleration sensor of small dimensions, of the same order of magnitude, can provide accurate acceleration measurements along three axes.

In a preferred alternative embodiment, the method for detecting a crossing of the Kármán line provides for calculating a comparison distance on the basis of the norms of the acceleration vectors measured by the acceleration sensor, the electronic unit being arranged to be able to calculate these norms and to perform a double integration over time of the norm of the periodically measured acceleration vector or of such a norm advantageously less the gravitational acceleration in the case of an accelerometer of the MEMS type in order to obtain a fictitious comparison distance, which is compared with the predetermined reference value or the calculated reference value mentioned above. The acceleration sensor provides acceleration vectors in a proper coordinate frame, yet the norm of the acceleration vector is independent of the coordinate frame, i.e. it is invariable, regardless of the spatial orientation of the coordinate frame in which this acceleration vector is given, so that an indeterminacy of the orientation of the measurement coordinate frame for the acceleration measurements is no longer problematic. This preferred alternative embodiment is highly advantageous because it overcomes the fact that a coordinate frame linked to the portable object, i.e. the coordinate frame defined by the acceleration sensor which is fixed relative to the portable object, has an orientation, relative to a terrestrial coordinate frame, which is variable during a space flight between the rocket launch base and the Kármán line, in particular because the rocket does not follow a vertical linear trajectory. Moreover, the orientation of the portable object can vary over time relative to the rocket, as a result of the movements of the user wearing it, particularly in the case of a wristwatch.

During the development of the portable object and of a method for detecting a crossing of the Kármán line by this portable object using, for this purpose, as the only measurements involved in the detection phase of this detection method, periodic measurements of the acceleration vector of the portable object and basing the calculations on the norms of the acceleration vectors measured, the inventors realised that such a method can lead, in certain specific situations, to an erroneous result, namely to a detection of the crossing of the Kármán line by the portable object when this event has not taken place. This is referred to as a “false positive”. This is a problem for a portable object, particularly for a watch whose purpose is to indicate an exceptional event to its user, namely a trip into space. It is thus desirable to find a solution for determining the likelihood of the portable object detecting, autonomously during the detection phase, the crossing of the Kármán line, in order to be able to validate or not such a detection.

Among the situations that could lead to an erroneous result from the envisaged detection method, in particular from the preferred alternative embodiment, there is in particular a situation where the portable object is subjected to a succession of sudden accelerations, for example a series of impacts occurring close together. This can happen in a number of voluntary or involuntary situations, or even when playing a sport such as tennis or table tennis while wearing, on the wrist, a watch designed for the spatial application in question. Other activities, such as running, can further lead to erroneous detection without the watch worn on the user's wrist being subjected to strong impacts. Moreover, acrobatic flights in an aeroplane can easily result in a “false positive”, as can certain attractions in an amusement park, when the wearer climbs into a piece of equipment that is subject to relatively high acceleration, as in the case of a “roller coaster”. Other specific situations can also lead to the erroneous detection of a crossing of the Kármán line in the present context, for example if the watch is placed in a device exerting a significant centripetal force on an object placed inside the device (for example a clothes dryer or even a salad spinner). The purpose of the invention is thus to provide means for detecting at least a certain number of cases in which a detection of a crossing of the Kármán line is uncertain, unlikely or improbable, so as to be able to invalidate such an erroneous detection.

In order to address the aforementioned problem, the invention relates to a method for validating a detection of a crossing of the Kármán line, defined by a predetermined altitude, by an object portable by a user and comprising a detection device formed by an acceleration sensor, a time base and an electronic unit, this detection device being arranged so as to be able, during a detection phase of a method for detecting crossing of the Kármán line implemented by the portable object, to measure accelerations experienced by the portable object and to process, in the electronic unit, these acceleration measurements so as to enable a detection of a crossing of the Kármán line by the portable object on the basis of these acceleration measurements and of data recorded in the portable object prior to the detection phase of the detection method. The method for validating a detection of crossing of the Kármán line exploits successive measurements made by the portable object, during said detection phase of the detection method, for at least one variable which depends on at least one force exerted on this portable object. The validation method is performed by the electronic unit which calculates at least one confidence index relating to said successive measurements and which then checks whether at least one condition given for said at least one confidence index is met, so as to validate or not a detection of the crossing of the Kármán line by the portable object.

In an advantageous alternative embodiment, the acceleration sensor measures a proper acceleration vector of the portable object in a coordinate frame of this watch. Said variable is the norm of the proper acceleration vector less the norm of the gravitational acceleration, the proper acceleration vector of the portable object being equal to the vector sum of the forces to which this portable object is subjected, except for the force of gravity, divided by its mass.

In a preferred alternative embodiment, the portable object further comprises an angular velocity sensor (gyrometer), and a confidence index is defined by a function given on angular velocity measurements made, preferably periodically, by the angular velocity sensor. Advantageously, the angular velocity sensor (gyrometer) is formed by a microelectromechanical system (MEMS).

### BRIEF DESCRIPTION OF THE FIGURES

The invention will be described in greater detail below with reference to the accompanying drawings, given by way of examples that are in no way limiting, in which:

FIG. 1 diagrammatically shows a watch according to a preferred embodiment of the invention;

FIG. 2 shows a trajectory T_{F}(x), which trajectory is interrupted in the drawing, that is taken by a rocket during a flight in space, between take-off and the crossing of the Kármán line L_{K}, as well as various variables relating to the flight along this trajectory and involved in an advantageous method for detecting crossing of the Kármán line;

FIG. 3 shows an enlarged view, relative to FIG. 2, of a vector sum of various accelerations involved in the advantageous detection method, which provides for measuring the proper acceleration of the watch, the orthogonal axes Xₜ and Zₜ being parallel to the X and Z axes of FIG. 2 and having their origin at the point P_{S}(t) on the trajectory T_{F}(x) of the rocket concerned, this point P_{S}(t) defining an altitude H_{F}(t);

FIG. 4 shows a theoretical curve of the acceleration of motion of a rocket of a certain type as a function of time;

FIG. 5 shows a theoretical curve of the angle of inclination of said rocket over time; and

FIG. 6 shows a theoretical curve of the altitude of said rocket over time, which defines a theoretical flight time between rocket take-off and the crossing of the Kármán line.

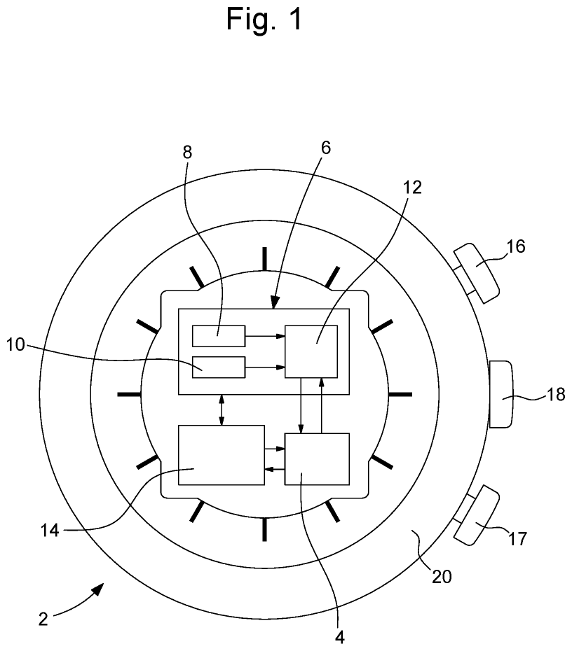

### DETAILED DESCRIPTION OF THE INVENTION

With reference to the figures, an advantageous embodiment of a watch according to the invention, an advantageous method for detecting a crossing of the Kármán line by a watch according to the invention, and the method for validating a detection of a crossing of the Kármán line according to the invention will be described below.

The watch 2 comprises a memory 4, a time base and a detection and validation device 6, which device comprises an acceleration sensor 8 capable of measuring an acceleration vector of the watch in a three-dimensional coordinate frame linked to the watch, and an electronic processing unit 12, hereinafter also referred to as the ‘electronic unit’, which is arranged such that it can in particular process measurements supplied by the acceleration sensor 8. The watch further comprises an electronic control unit 14, which is in particular arranged such that it can activate the detection and validation device 6 in response to actuation of an external control member. This watch 2 is equipped with various external control members, in particular two push-buttons 16 and 17 and a stem-crown 18 arranged on the case 20, externally thereto. It should be noted that the watch can be equipped with tactile control means, in particular a tactile crystal covering the display means, such tactile control means being provided, for example, for data input into the watch memory 4 and/or for controlling the display of certain data by the display means, in particular before and after a space flight or a space mission. In a particular alternative embodiment, the watch comprises an analogue display, formed by hands associated with a graduation, and a digital display formed by an electronic display module defining a major part of the dial of the watch.

The electronic unit 12 is arranged, in association with the acceleration sensor 8 and the memory 4, such that it can detect, at least for a rocket of a given type, crossing of the Kármán line L_{K} by the rocket, solely by means of the watch 2 on board this rocket. Detection is thus carried out autonomously, during a detection phase of the detection method implemented by the watch, by the detection device included in the watch's detection and validation device 6. The Kármán line L_{K} is defined by a given altitude H_{D} or by an altitude H_{S} that can be selected by a user from within a given range of values, in particular between 85 and 110 km, either directly or via the selection of another spatial variable. The term ‘given altitude’ is understood to mean an altitude that has been predefined/predetermined by the manufacturer of the watch or by an authorised person or company, and not by a user.

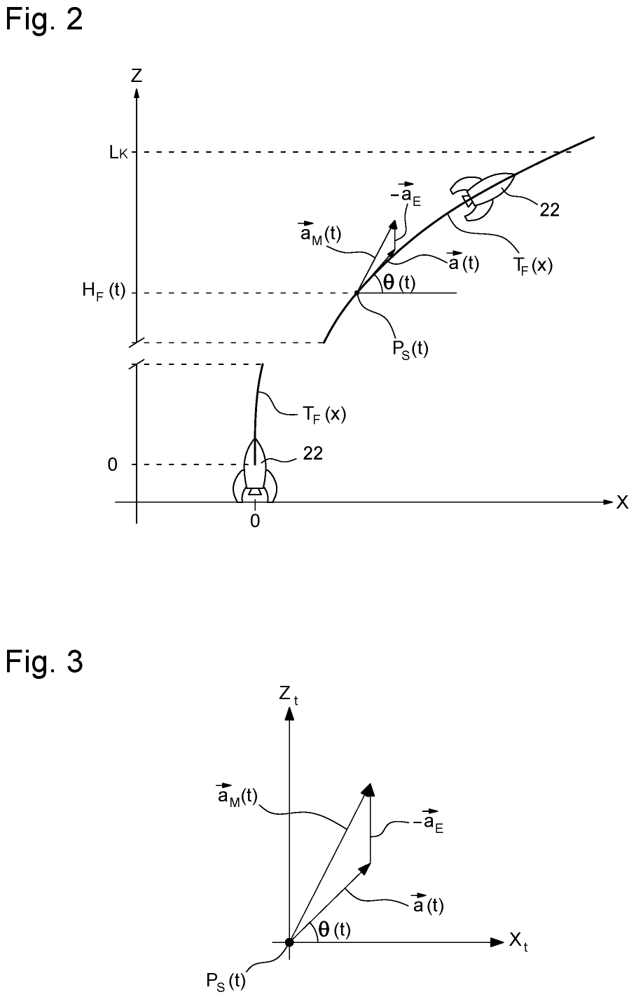

An advantageous detection method for detecting the crossing of the Kármán line L_{K}, defined by a given altitude H_{D} or by a selected altitude H_{S}, by a rocket 22, of a given type, by means of the watch 2 on board this rocket, provides that the acceleration sensor 8 is arranged to measure an acceleration vector a_{M}* of the watch, in a three-dimensional coordinate frame linked to this watch, and the electronic unit 12 is arranged to be able to process the measurements supplied by the acceleration sensor. The proper acceleration vector a_{M}* is equal, as a first approximation for a rocket, to an acceleration of motion vector a* of this watch minus the gravitational acceleration vector a_{E}* at any instant/at any time t. It should be noted that the asterisk (*) is used here to indicate a vector, whereas in FIGS. 2 and 3, the vectors are indicated in the conventional manner by arrows located above the variables concerned. The proper acceleration vector of the watch is equal to a vector sum of the forces experienced by the watch, except for the force of gravity, divided by its mass. In other words, the proper acceleration of an object is the acceleration that this object undergoes for an observer in free fall.

The detection method comprises a preliminary phase, which precedes placement of the portable object on board the rocket for the scheduled space flight, comprising the following preliminary steps of:
A) Providing a nominal acceleration of motion A_{N}(t) for the rocket 22, as a function of time t, from rocket take-off, defining a time zero, at least until one passage through the given altitude H_{D} for the Kármán line L_{K}, this nominal acceleration of motion being a scalar value (the norm of a nominal acceleration of motion) in a unit equal to the gravitational pull of the Earth (this dimensionless scalar value therefore corresponding to the norm of the vector of nominal acceleration of motion divided by the norm of the gravitational pull of the Earth).
B) Providing a theoretical tilt angle θ_{T}(t) for the rocket of the given type, relative to a horizontal plane and as a function of time t, from rocket take-off until at least one crossing of the given altitude H_{D}.
C) Providing or determining a theoretical time of flight T_{K} for the rocket of the given type from rocket take-off to the crossing of the given altitude H_{D}.
D) On the basis of said nominal acceleration of motion and of said theoretical tilt angle, determining a theoretical proper acceleration A_{PT}(t), as a function of time, for the rocket of the given type, the value of this theoretical proper acceleration being defined, in a unit equal to the gravitational pull of the Earth, by the following formula:

$${A}_{PT} ( t ) = \sqrt{1 + 2 \cdot {A}_{N} ( t ) \cdot sin {θ}_{T} ( t ) + {A}_{N}^{2} ( t )}$$

E) Calculating, by numerical and/or mathematical means, a theoretical measurement distance D_{MT} defined by a double integral of the theoretical proper acceleration A_{PT}(t), between time zero (t=0) corresponding to rocket take-off and time T_{K} corresponding to the theoretical time of flight, or of this theoretical proper acceleration less the norm of the gravitational acceleration; the theoretical measurement distance D_{MT} divided by the given altitude H_{D} for the Kármán line L_{K} defining, for the rocket of the given type, a correction factor F_{C}.
F) Recording the theoretical measurement distance D_{MT} and/or the correction factor F_{C} in the watch memory, this correction factor F_{C} then being, before a take-off of the rocket defining a beginning of said space flight, where applicable, multiplied by the selected altitude H_{S} so as to obtain a reference distance D_{MR}.

Afterwards, the detection method comprises a detection phase comprising the following detection steps:
G) Before rocket take-off, activating the detection device of the watch on board this rocket.
H) Periodically measuring, at a measurement frequency F_{M}, the proper acceleration vector of the watch, in the three-dimensional coordinate frame of this watch, by means of said detection device, and calculating in the electronic unit, for each measurement, the norm A_{M}(tₙ) of the measured proper acceleration vector, respectively a corrected norm equal to the norm A_{M}(tₙ) less the norm of the gravitational acceleration, tₙ being a time equal to n·P where n is a number of measurements carried out at least since rocket take-off, incremented by one unit with each new measurement, and P is the time period defined by the measurement frequency.
I) Calculating numerically, in the electronic unit, a double integral over time, from rocket take-off, respectively at least from rocket take-off, of the norm of the proper acceleration vector of the watch, respectively of this norm less the norm of the gravitational acceleration, the norm of the proper acceleration vector being determined on the basis of said norms A_{M}(tₙ) of the proper acceleration vector measured periodically, in order to obtain comparison distances D_{C}(tₘ) for times tₘ, where m is a positive integer, each m corresponding to one said number n.
J) Comparing each comparison distance D_{C}(tₘ) with the theoretical measurement distance D_{MT} in the case of a given altitude H_{D} or with the reference distance D_{MR} in the case of a selected altitude H_{S} and, when a comparison distance D_{C}(tₘ) is greater than the theoretical measurement distance D_{MT}, or respectively the reference distance D_{MR}, recording, in the memory of the portable object, a detection, by the detection device, of the crossing of the Kármán line by this portable object.

The term ‘acceleration of motion’ is understood to mean an acceleration corresponding to the time derivative of the velocity, this acceleration of motion defining, at all times, a vector tangent to the trajectory of the rocket, and thus of the portable object, in space, i.e. a vector collinear with the instantaneous direction vector of the rocket. The term ‘nominal’ is understood to mean a value given in the specification for the type of rocket in question or for a certain rocket; it is thus a theoretical value, in this case dependent on time, predicted for the rocket in question and which results from its design and from the planning of a space flight with such a rocket, in particular from its launch until it crosses the Kármán line in the context of the present invention.

In a preferred alternative embodiment of the detection method, the acceleration sensor used to measure the proper acceleration vector of the watch, and thus normally of the rocket, is a microelectromechanical system (MEMS) incorporated into this watch.

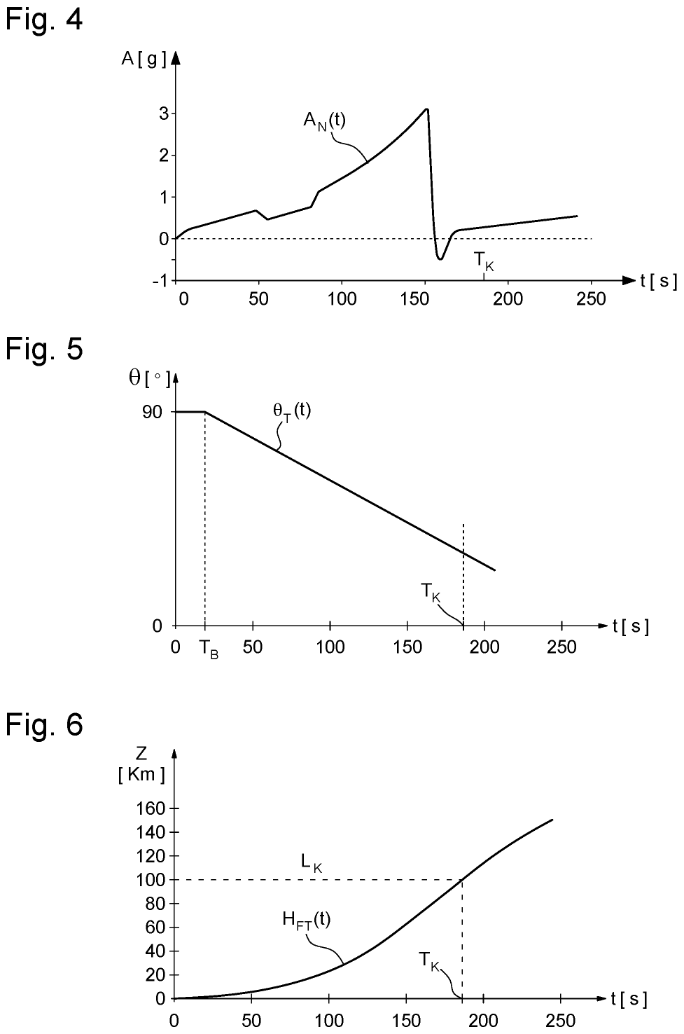

With regard to step A, it should also be noted that the theoretical acceleration of motion A_{N}(t) can momentarily be negative, i.e. the velocity of the rocket can momentarily decrease, as shown in the graph in FIG. 4. Thus, the nominal acceleration of motion is provided with its mathematical sign and must be entered with this mathematical sign in the formula given in step D).

With regard to step B) of the detection method, FIG. 5 shows an example for the curve of the theoretical tilt angle θ_{T}(t) of the rocket concerned as a function of time. Until time T_{B}, the rocket follows a vertical direction such that the theoretical tilt angle θ_{T}(t) is 90° between time zero and time T_{B}.

FIG. 2 shows an example of a trajectory z=T_{F}(x) of the rocket 22 (which trajectory is interrupted in this figure for reasons of scale). It should be noted that the examples given in the figures in no way limit the theoretical curves that can be envisaged, which are typically specific to each type of rocket (type of launch vehicle in particular for a space shuttle). The tilt angle θ(t), at a time t, between the direction of the rocket at time t and a horizontal plane is defined by the tangent to the trajectory z=T_{F}(x) of the rocket at its spatial position P_{S}(t), the variable x being a function of time.

With regard to step C) relating to the theoretical time of flight T_{K}, it is possible, in a simplified alternative embodiment, to estimate this theoretical time of flight on the basis of at least one previous space flight with a rocket of the type concerned. In an advantageous alternative embodiment, the theoretical time of flight T_{K} is to be determined by mathematical and numerical means on the basis of the nominal acceleration of motion A_{N}(t) and the theoretical tilt angle θ_{T}(t) of the rocket. To this end, the following approach can be taken by defining a theoretical distance L_{T}(t) travelled by the rocket as a function of time. A mathematical relationship can be established between the theoretical altitude H_{FT}(t) of the rocket in flight and the theoretical distance L_{T}(t) travelled by this rocket. An infinitesimal/elementary variation in the theoretical altitude dH_{FT}(t)=dL_{T}(t)·sinθ_{T}(t) where dH_{FT}(t) is an infinitesimal/elementary variation in the theoretical distance travelled. On the other hand, the variation dL_{T}(t)=V_{N}(t)·dt where V_{N}(t) is the nominal velocity of the rocket at time t and dt is an infinitesimal/elementary variation in time. The nominal velocity V_{N}(t) can be determined mathematically and/or numerically on the basis of the nominal acceleration of motion A_{N}(t), given that the velocity is equal to the integral of acceleration over time. We can thus define the infinitesimal/elementary variation dH_{FT}(t) of the theoretical altitude H_{FT}(t), on the basis of the mathematical relationships given above, as a function of given (nominal/theoretical) variables. This gives

$${dH}_{FT} ( t ) = {V}_{N} ( t ) \cdot sin {θ}_{T} ( i ) \cdot dt , where {V}_{N} ( t ) = {\int }_{0}^{t} {A}_{N} ( t ) \cdot dt$$

The theoretical altitude H_{FT}(t) is equal to the integral over time of dH_{FT}(t) calculated by mathematical and/or numerical means. To determine the theoretical time of flight T_{K}, the equation H_{FT}(T)=H_{D} is solved, where H_{D} is the given altitude and T is the variable.

FIG. 6 shows an example for the curve of theoretical altitude H_{FT}(t) as a function of time on the basis of the nominal acceleration of motion A_{N}(t) curve given in FIG. 4 and of the theoretical tilt angle θ_{T}(t) curve given in FIG. 5.

Steps D) and E) of the detection method are characterised in that they are designed to allow a theoretical measurement distance D_{MT} corresponding to a predetermined reference value to be accurately determined, against which a comparison distance subsequently accurately calculated in the electronic unit of the watch can be compared on the basis of the proper acceleration measurements supplied by the acceleration sensor 8 arranged in the watch, during a space flight with a rocket carrying this watch. In the main embodiment of the watch 2, the autonomous detection device is considered to use, as its measurement means, for detecting a crossing of the Kármán line, only an acceleration sensor arranged to be able to measure vectors of the proper acceleration experienced by the watch. The method involves determining beforehand, i.e. in a preliminary step prior to the space flight in question, a theoretical measurement distance D_{MT} which is a fictitious theoretical distance in that it does not correspond to a distance theoretically travelled by the rocket between the ground and the Kármán line, but rather to a theoretical distance resulting from the fact that the watch's proper acceleration is being measured. Moreover, given the limited means of measurement, a reference value will be supplied, which value depends only on the norm of the proper acceleration, the vector whereof in a coordinate frame of the watch 2 is supplied by the acceleration sensor, advantageously corrected by the norm of the gravitational acceleration by subtracting it from the norm of the proper acceleration, and on the trajectory of the rocket. A crossing of the Kármán line is thus intended to be defined on the basis of the norm of the proper acceleration of the watch and thus normally of the rocket carrying it.

The detection method takes into account the fact that the norm of the proper acceleration vector, for a given acceleration of motion, varies according to the tilt of the rocket. In fact, this norm, less the norm of the gravitational acceleration, does not give the acceleration of motion of the watch/rocket when the rocket does not have a vertical direction. FIGS. 2 and 3 show, for a rocket, the vector relationship between the acceleration of motion a*, the measured proper acceleration a_{M}* and the gravitational acceleration a_{E}*. An acceleration of motion vector a(t)* and a measured proper acceleration vector a_{M}(t)* correspond to the spatial position P_{S}(t) of the rocket at the time t of a space flight, the gravitational acceleration vector a_{E}* always being vertical and independent of the spatial position of the rocket. It should be noted that the small centripetal acceleration experienced by the rocket as it gradually tilts is not taken into account in the relationship between the rocket's proper acceleration, which includes such a centripetal acceleration, and the rocket's acceleration of motion, as this centripetal acceleration is small and insignificant for a rocket between the ground and the Kármán line.

Step F) provides for storing, prior to a space flight, i.e. before rocket take-off, the theoretical measurement distance D_{MT} and/or the correction factor F_{C} in the watch's memory. The correction factor F_{C} is useful for obtaining a reference distance D_{MR} when it is expected that the user will be able to provide the watch with a selected altitude H_{S} for the Kármán line, the correction factor F_{C} being, in this case, multiplied by the selected altitude H_{S} for the Kármán line to calculate the reference distance D_{MR}. It should be noted that this reference distance D_{MR} is in fact an approximate theoretical distance, given the linear approximation which is made here from the theoretical measurement distance D_{MT}, which is determined precisely for the given altitude H_{D}.

For the reasons set out in the summary of the invention, detection of a crossing of the Kármán line by a watch, advantageously arranged to be able to implement the detection method described above, is reliable insofar as the detection device is activated during a space flight, preferably shortly before take-off, but this detection method nonetheless has a major drawback already mentioned before. Indeed, the previously-described advantageous detection method is characterised in that, in order to detect a crossing of the Kármán line, it uses as its only sensor, a 3D accelerometer, advantageously of the MEMS type; however, such a detection can, in particular circumstances, be obtained erroneously.

Generally speaking, the method for validating the detection of a crossing of the Kármán line, defined by a predetermined altitude, is implemented by an object portable by a user and is arranged to be able, during a detection phase of a method for detecting crossing of the Kármán line implemented by the portable object, to measure accelerations of the portable object and to process these acceleration measurements in the electronic unit so as to enable a detection of crossing of the Kármán line by the portable object based on these acceleration measurements and data recorded in this portable object prior to the detection phase of the detection method. According to one general implementation, the method for validating a detection of crossing of the Kármán line exploits successive measurements made by the portable object, during said detection phase of the detection method, for at least one variable which depends on at least one force exerted on this portable object. The validation method is performed by the electronic unit which calculates at least one confidence index, relating to said successive measurements, and which the checks whether at least one given condition for said at least one confidence index is met, so as to validate, or not, a detection of crossing of the Kármán line by the portable object.

Three specific confidence indexes are described below, which make it possible to validate or not a detection of a crossing of the Kármán line by the watch, using conditions, each of which are given for at least one of these confidence indexes, which are checked during the validation process.

The first confidence index C1(N) is defined by the following function:

$$C 1 ( N ) = 1 - \frac{1}{N} {\sum }_{j = 1}^{N} δ ( {A}_{j} > L 1 )$$

N being a number of acceleration measurements carried out, during the detection phase of the considered detection method, and Aⱼ is a value of the acceleration supplied by the acceleration sensor during a j^{th} acceleration measurement or calculated in the electronic unit on the basis of this j^{th} acceleration measurement, where j=1 to N. The value L1 is a given limit for the acceleration values Aⱼ.

The o function gives the value ‘1’ if the condition to which it relates is true/satisfied and the value ‘0’ if this condition is false/not satisfied. C1(N) thus has a value between ‘0’ and ‘1’. The closer the value of the function C1(N) is to ‘1’, the greater the confidence regarding the detection of a crossing of the Kármán line.

The second confidence index C2(N) is defined by the following function:

$$C 2 ( N ) = 1 - \frac{1}{N} {\sum }_{q = 1}^{N} δ ( {V}_{q} > L 2 )$$

N being a number of acceleration measurements made, during the detection phase of the considered detection method, and V_{q} is a velocity obtained by numerical integration over time of an acceleration determined by said values Aⱼ for j=1 to q. The value L2 is a given limit for said velocity. C2(N) also has a value between ‘0’ and ‘1’. The closer the value of the function C2(N) is to ‘1’, the greater the confidence.

In particular, incremental integration can be used to determine the velocity V_{q} after q successive measurements have been taken at a frequency F equal to 1/P. The velocity V_{q} is in fact an increase in velocity over the time interval q·P in which these q successive measurements are taken. The velocity V_{q} is thus given by the formula

$$V q = {\sum }_{j = 1}^{q} Aj \cdot P$$

The third confidence index C3(M) is defined by the following function:

$$C 3 ( M ) = 1 - \frac{1}{M} {\sum }_{k = 1}^{M} δ ( {W}_{k} > L 3 )$$

M is a number of angular velocity measurements which are made by an angular velocity sensor (gyrometer) incorporated in the watch for this purpose, during the detection phase of the considered detection method. Wₖ is a value of the angular velocity supplied by the angular velocity sensor during the k^{th} angular velocity measurement or calculated on the basis of the k^{th} measurement, where K=1 to M. The value L3 is a given limit for the values Wₖ. The function C3(M) has a value between ‘0’ and ‘1’. The closer the value of C3(M) is to ‘1’, the greater the confidence regarding the detection of a crossing of the Kármán line.

It should be noted that, according to three basic alternative embodiments, the validation method according to the invention relates to a single confidence index, among the three confidence indices, and to a respective given condition which is verified at least following detection of a crossing of the Kármán line by the watch. In the basic alternative embodiment concerning the third confidence index, an angular velocity sensor 10 is also incorporated into the watch 2 and associated with the detection device to form a detection and validation device capable of implementing said validation process. The given condition checks whether the third confidence index C3(M) is greater than a reference value R2 selected between ‘0.5’ and ‘1’. In a preferred alternative embodiment, the reference value R2 is selected between ‘0.7’ and ‘0.9’ inclusive. In a particular case, the value L3 is equal to 200 rad/s and the reference value R2 is equal to 0.8.

In an advantageous alternative embodiment, because it is safer, the validation method relates to the first and second confidence indices and to the same given condition for these first and second confidence indices. In a particular case, the same given condition is a condition on the average of the first confidence index and of the second confidence index. This same condition checks whether said average is greater than a first reference value R1, which is selected between ‘0.5’ and ‘1’. In a preferred alternative embodiment, the first reference value R1 is selected between ‘0.7’ and ‘0.9’ inclusive. In a particular case for a rocket of a certain given type, the value L1 is equal to 20 m/s², the value L2 is equal to 1000 m/s and the reference value R1 is equal to 0.8.

In a particular alternative embodiment, relating in particular to the advantageous detection method described above, the acceleration sensor 8 measures a proper acceleration vector of the portable object in a coordinate frame of this watch and said acceleration value Aⱼ is the norm of the proper acceleration vector less the norm of the gravitational acceleration, whereby this proper acceleration vector is obtained during the j^{th} acceleration measurement. It should be noted that the proper acceleration vector of the watch is equal to the vector sum of the forces experienced by the watch, except for the force of gravity, divided by its mass. In this case, the acceleration sensor is a microelectromechanical system (MEMS).

In an advantageous alternative embodiment, the validation method relates to the three confidence indices and at least one given condition relating to the three confidence indices. In a preferred alternative embodiment, the validation method relates to the three confidence indices and provides a first given condition relating to the first and second confidence indices and a second given condition relating to the third confidence index. Thus, validation of a detection of a crossing of the Kármán line is obtained insofar as the two given conditions are met. In a particular case, the first condition is identical to the condition on the average of the first and second confidence indices, given previously, and the second condition is identical to that for the basic alternative embodiment concerning the third confidence index, also given previously. This preferred alternative embodiment makes it possible to rule out erroneous results (‘false positives’) in all of the particular situations listed in the summary of the invention.

In a preferred alternative embodiment, the angular velocity sensor is formed by a microelectromechanical system (MEMS). It has been stated in the summary of the invention that angular velocity sensors of the MEMS type lack accuracy and are not suitable for correctly detecting a crossing of the Kármán line. The present invention does not ignore this fact; however, the inventors have found that such angular velocity sensors can nevertheless provide data that is sufficiently accurate to allow them to be used in a method for validating the detection of a crossing of the Kármán line according to the invention. A crossing of the Kármán line is thus intended to be detected without using measurements from a gyrometer, and such a detection is to subsequently be validated using measurements from a gyrometer, whose accuracy is relatively unimportant when validating such a detection by eliminating erroneous detections (‘false positives’) in situations involving a relatively high centripetal force.

The invention further relates to an object portable by a user, in particular a watch 2, which comprises a detection device formed by an acceleration sensor 8, a time base and an electronic unit 12, this detection device being arranged to be able to measure, preferably periodically, accelerations of this portable object by means of the acceleration sensor. The detection device is arranged to be able to autonomously detect, during a space flight of a rocket, a crossing of the Kármán line, defined by a predetermined altitude, by the portable object by processing in the electronic unit at least the acceleration measurements made during this space flight. Afterwards, the detection device forms part of a detection and validation device 6 which is also arranged so as to be able to implement the method for validating a detection of a crossing of the Kármán line by the portable object according to the invention.

In a preferred embodiment, the portable object, in particular the watch 2, is characterised in that it further comprises an angular velocity sensor 10 which is associated with the detection device in order to implement the validation method according to a preferred alternative embodiment; and in that the electronic unit 12 is arranged in such a way as to be able to implement the method for validating a detection of a crossing of the Kármán line, by this portable object, which validation method makes use of a confidence index relating to the angular velocity, in particular the third confidence index and the given condition relating thereto. Within the scope of the invention, the detection device is thus developed so that it is also a device for validating each detection. More specifically, the device 6 comprises a part for the actual detection of a crossing of the Kármán line and a part for the validation of such a detection, these two parts sharing hardware resources, in particular the electronic unit. The device 6 is thus a device for detecting a crossing of the Kármán line and for validating each detection. No angular velocity sensor is provided and thus used in the detection part specifically designed to detect a crossing of the Kármán line; however, an angular velocity sensor 10 is advantageously provided in the part for validating each detection.

In an advantageous alternative embodiment, the angular velocity sensor 10 is formed by a microelectromechanical system (MEMS).

1. A method for validating a detection of a crossing of the Kármán line, defined by a predetermined altitude, by an object portable by a user and comprising a detection device formed by an acceleration sensor, a time base and an electronic unit, this detection device being arranged so as to be able, during a detection phase of a method for detecting crossing of the Kármán line implemented by the portable object, to measure accelerations experienced by the portable object and to process, in the electronic unit, these acceleration measurements so as to enable a detection of a crossing of the Kármán line by the portable object on the basis of these acceleration measurements and of data recorded in the portable object prior to the detection phase of the detection method; the method for validating a detection of crossing of the Kármán line exploiting successive measurements made by the portable object, during said detection phase of the detection method, for at least one variable which depends on at least one force exerted on this portable object; the validation method being performed by the electronic unit which calculates at least one confidence index relating to said successive measurements which then checks whether at least one condition given for said at least one confidence index is met, so as to validate or not a detection of the crossing of the Kármán line by the portable object.

2. The validation method according to claim 1, wherein said confidence index is defined by the following function:
$$C 1 ( N ) = 1 - \frac{1}{N} {\sum }_{j = 1}^{N} δ ( {A}_{j} > L 1 )$$
where N is a number of said acceleration measurements carried out, C1(N) is the confidence index for the N measurements, Aⱼ is a value of the acceleration supplied by the acceleration sensor during a j^{th} acceleration measurement or calculated in the electronic unit on the basis of this j^{th} acceleration measurement, where j=1 to N, the value L1 is a given limit for said acceleration values Aⱼ, and where the δ function gives the value ‘1’ if the condition to which it relates is true and the value ‘0’ if this condition is false, with C1(N) thus having a value between ‘0’ and ‘1’.

3. The validation method according to claim 2, wherein said confidence index is a first confidence index, said function is a first function and said given condition is a first condition; wherein the electronic unit further calculates a second confidence index which is defined by a second function given on said acceleration measurements and which verify the first given condition, in the case where the latter also relates to the second confidence index, or a second given condition in the opposite case, so as to validate or not a detection of the crossing of the Kármán line by the portable object; and wherein the second confidence index is defined by the following function:
$$C 2 ( N ) = 1 - \frac{1}{N} {\sum }_{q = 1}^{N} δ ( {V}_{q} > L 2 )$$
C2(N) being the second confidence index, for N acceleration measurements carried out, the value of which lies between ‘0’ and ‘1’, V_{q} being a velocity obtained by numerical integration over time of an acceleration determined by said values Aⱼ for j=1 to q, and the value L2 being a limit given for said velocity.

4. The validation method according to claim 3, wherein said first given condition relates to the first confidence index and the second confidence index, this first given condition being verified at least when the processing of the acceleration measurements, carried out by the electronic unit, gives as a result, after N_{K} acceleration measurements have been taken, that the portable object has crossed the Kármán line so as to validate or not this result, said first condition being a condition on the average of the first and second confidence indices and this condition being met if this average is greater than a first reference value R1, which is selected between ‘0.5’ and ‘1’, preferably between ‘0.7’ and ‘0.9’ inclusive.

5. The validation method according to claim 2, wherein the acceleration sensor measures a proper acceleration vector of the portable object in a coordinate frame of this watch, said value Aⱼ of the acceleration being the norm of the proper acceleration vector, obtained during the j^{th} acceleration measurement, less the norm of the gravitational acceleration, the proper acceleration vector of the portable object being equal to the vector sum of the forces to which this portable object is subjected, except for the force of gravity, divided by its mass.

6. The validation method according to claim 5, wherein the acceleration sensor is formed by a microelectromechanical system (MEMS).

7. The validation method according to claim 1, wherein the portable object further comprises an angular velocity sensor; and wherein said confidence index is defined by a function given on angular velocity measurements made, preferably periodically, by the angular velocity sensor during said detection phase of the detection method.

8. The validation method according to claim 7, wherein said confidence index is defined by the following function:
$$C 3 ( M ) = 1 - \frac{1}{M} {\sum }_{k = 1}^{M} δ ( {W}_{k} > L 3 )$$
where C3(M) is the confidence index, for M angular velocity measurements made, Wₖ is a value of the angular velocity provided by the angular velocity sensor during the k^{th} angular velocity measurement or calculated in the electronic unit on the basis of this k^{th} measurement, where K=1 to M, the value L3 is a given limit for the values Wₖ, and the function δ gives the value ‘1’ if the condition to which it relates is true and the value ‘0’ if this condition is false, with C3(M) thus having a value between ‘0’ and ‘1’.

9. The validation method according to claim 8, wherein said given condition is satisfied if said confidence index is greater than a reference value R2, which is selected between ‘0.5’ and ‘1’, preferably between ‘0.7’ and ‘0.9’ inclusive.

10. The validation method according to claim 2, wherein the portable object further comprises an angular velocity sensor; and wherein the validation method calculates another confidence index, defined by a given function on angular velocity measurements made, preferably periodically, by the angular velocity sensor during said detection phase of said method for detecting crossing of the Kármán line, and verifying at least one condition given for the other confidence index, so as to validate or not a detection of the crossing of the Kármán line by the portable object.

11. The validation method according to claim 10, wherein said additional confidence index is defined by the following function:
$$C 3 ( M ) = 1 - \frac{1}{M} {\sum }_{k = 1}^{M} δ ( {W}_{k} > L 3 )$$
where C3(M) is the additional confidence index, for M angular velocity measurements made, Wₖ is a value of the angular velocity provided by the angular velocity sensor during the k^{th} angular velocity measurement or calculated in the electronic unit on the basis of this k^{th} measurement, where K=1 to M, the value L3 is a given limit for the values Wₖ, and the function δ gives the value ‘1’ if the condition to which it relates is true and the value ‘0’ if this condition is false, with C3(M) thus having a value between ‘0’ and ‘1’.

12. The validation method according to claim 11, wherein the given condition for said additional confidence index is satisfied if this additional confidence index is greater than a second reference value R2, which is selected between ‘0.5’ and ‘1’, preferably between ‘0.7’ and ‘0.9’ inclusive.

13. The validation method according to claim 7, wherein the angular velocity sensor is formed by a microelectromechanical system (MEMS).

14. A portable object (2), portable by a user and comprising a detection device formed by an acceleration sensor (8), a time base and an electronic unit (12), this detection device being arranged to be able to measure, preferably periodically, accelerations of this portable object by means of the acceleration sensor (8); wherein the detection device is arranged to be able to autonomously detect, during a space flight of a rocket, a crossing of the Kármán line, defined by a predetermined altitude, by the portable object by processing, in the electronic unit, at least the acceleration measurements made during this space flight; and wherein the detection device forms part of a detection and validation device (6) which is also arranged so as to be able to implement the method for validating a detection of a crossing of the Kármán line by the portable object according to claim 1.

15. The portable object (2) according to claim 14, wherein the acceleration sensor (8) is formed by a microelectromechanical system (MEMS).

16. The portable object (2) according to claim 14, wherein the detection and validation device (6) further comprises an angular velocity sensor (10).

17. The portable object (2) according to claim 16, wherein the angular velocity sensor (10) is formed by a microelectromechanical system (MEMS).

18. The portable object (2) according to claim 14, wherein the portable object is a watch (2).
